(19) United States
(12) Patent Application Publication
(10) Pub. No.: US 2023/0366047 A1
(43) Pub. Date: Nov. 16, 2023

(54) Blast furnace for ironmaking production

(71) Applicant: ArcelorMittal, Luxembourg (LU)

(72) Inventors: Edouard IZARD, Saint Julien Les Metz (FR); Dominique SERT, Montoy Flanville (FR)

(21) Appl. No.: 18/026,046

(22) PCT Filed: Sep. 15, 2020
(86) PCT No.: PCT/IB2020/058570

§ 371 Date: Mar. 13, 2023

(51) Int. Cl. C21B 5/06; C21B 7/16; C21B 5/00; F27B 1/14; F27D 1/00

(52) U.S. Cl. CPC C21B 5/06; C21B 7/16; C21B 5/001; F27B 1/14; F27D 1/0003; C21B 2005/005; F27M 2003/13

(57) ABSTRACT

A blast furnace for ironmaking production wherein iron ore is at least partly reduced by a reducing gas which is injected in the stack of the blast furnace. The blast furnace includes an external and an internal wall, having a thickness Tᵢₙₜ, in contact with matters charged into the blast furnace. The thickness Tᵢₙₜ of the internal wall is substantially constant above and below the injection area of a reducing gas.

The invention is related to a blast furnace for ironmaking production.

### BACKGROUND

In blast furnaces, the conversion of the iron-containing charge (sinter, pellets and iron ore) to cast iron is conventionally carried out by reduction of the iron oxides by a reducing gas (in particular containing CO, H2 and N2), which is formed by combustion of coke at the tuyeres located in the bottom part of the blast furnace where air preheated to a temperature between 1000° C. and 1300° C., called hot blast, is injected.

In order to increase the productivity and reduce the costs, auxiliary fuels are also injected at the tuyeres, such as coal in pulverized form, fuel oil, natural gas or other fuels, combined with oxygen enrichment of the hot blast.

The gas recovered in the upper part of the blast furnace, called top gas, mainly consists of CO, CO2, H2 and N2 in respective proportions of 20-28% v, 17-25% v, 1-5% v and 48-55% v. These gases are generally used in other parts of the plant as fuel and/or in a power plant for electricity production. Blast furnaces are therefore significant producers of CO2.

### SUMMARY OF THE INVENTION

In view of the considerable increase in the concentration of CO2 in the atmosphere since the beginning of the last century and the subsequent greenhouse effect, it is essential to reduce emissions of CO2 where it is produced in a large quantity, and therefore in particular at blast furnaces.

For this purpose, during the last 50 years, the consumption of reducing agents in the blast furnace has been reduced by half so that, at present, in blast furnaces of conventional configuration, the consumption of carbon has reached a low limit linked to the laws of thermodynamics.

One known way of additionally reducing CO2 emissions is to reintroduce top gases that are purified of CO2 and that are rich in CO into the blast furnace. The use of CO-rich gas as a reducing agent thus makes it possible to reduce the coke consumption and therefore the CO2 emissions. This injection may be done at two levels, at the classical tuyere level, in replacement of hot blast and in the reduction zone of the blast furnace, for example near the shaft-belly corner of the blast furnace and above (lower stack of the blast furnace). This kind of blast furnace is notably known as Top Gas Recycling Blast Furnace (TGRBF).

The second level of injection does not currently exist in blast furnaces, a new level of injection has thus to be created and it must not detrimentally impair the working of the blast furnace. For example, the injection of reducing gas must not disturb the flow of matter inside the blast furnace which is key for the productivity.

There is a need for a blast furnace having a reduced environmental impact with same or improved level of productivity than prior art blast furnaces.

The present invention provides a blast furnace comprising an external and an internal wall having a thickness Tᵢₙₜ, an injection device for injecting the reducing gas through an injection outlet in an injection area, wherein the thickness Tᵢₙₜ of the internal wall is substantially constant above and below the injection area, the injection outlet is aligned with the internal wall and the injection device is able to inject the reducing gas at a speed inferior to 120 m/s.

The blast furnace of the invention may also comprise the following optional characteristics considered separately or according to all possible technical combinations:
the thickness Tᵢₙₜ of the internal wall is substantially constant over a height of at least 400 mm above and at least 400 mm below the injection area,
the blast furnace has a working height H and the reducing gas injection is performed at a height which is comprised between 20% and 70% of said working height H, starting from the tuyere level,
the blast furnace has a working height H and the reducing gas injection is performed at a height which is comprised between 20% and 70% of said working height H, starting from the tuyere level.

The invention is also related to an ironmaking method performed in a blast furnace according to the previous embodiments wherein the reducing gas contains part of top gas exhausted from the blast furnace during the ironmaking process. Said method may also comprise the following optional characteristics considered separately or according to all possible technical combinations:
the reducing gas is injected at a temperature comprised between 850° C. and 1200° C.,
the reducing gas contains preferentially between 65% v and 75% v of carbon monoxide CO, between 8% v and 15% v of hydrogen H2, between 1% v and 5% v of carbon dioxide CO2, remainder being mainly nitrogen N2

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates a side view of a blast furnace with reducing gas injection in the reduction zone

FIG. 2 illustrates an upper view of the blast furnace of FIG. 1

FIG. 3 illustrates a blast furnace according to an embodiment of the invention

### DETAILED DESCRIPTION

Elements in the figures are for illustration only and may not have been drawn to scale.

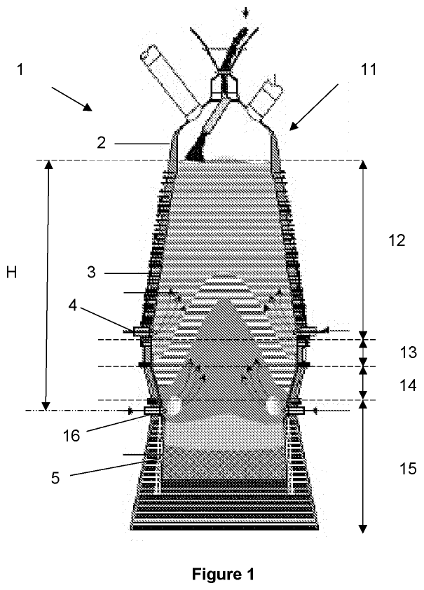

FIG. 1 is a side view of a blast furnace according to the invention. The blast furnace 1, comprises, starting from the top, a throat 11 wherein materials are loaded and gas exhaust, a stack—or shaft—12, a belly 13, a bosh 14 and a hearth 15. The materials loaded are mainly iron-bearing materials such as sinter, pellets or iron ore and carbon-bearing materials such as coke. The hot blast injection necessary to carbon combustion and thus iron reduction is performed by tuyeres 16 located between the bosh 14 and the hearth 15. In terms of structure, the blast furnace has an external wall, or shell 2, this shell 2 being covered, on the inside of the blast furnace, by a refractory lining and staves 3, as illustrated in FIG. 3, forming an internal wall 5. The blast furnace has an internal diameter Dᵢₙₜ which varies from the top to the bottom. To reduce consumption of coke, which is the main carbon provider for iron reduction, it has been envisaged to inject a reducing gas into the blast furnace in addition to the hot blast. This reducing gas injection is performed in the stack of the blast furnace, preferentially in the lower part of the stack.

In a preferred embodiment the reducing gas injection is performed at a height from the classical tuyere level corresponding to 20% and 70% of the working height H of the furnace. In a most preferred embodiment, the reducing gas injection is performed between 30% and 60% of the working height H of the furnace. The working height H of a blast furnace is the distance between the level of injection of hot blast through classical tuyeres and the zero level of charging, as illustrated in FIG. 1.

In a preferred embodiment the reducing gas which is introduced into the shaft furnace is top gas exhausted from said furnace which is subjected to gas treatment so as to remove dust and get appropriate composition, pressure and temperature. This reducing gas contains preferentially between 65% v and 75% v of carbon monoxide CO, between 8% v and 15% v of hydrogen H2, between 1% v and 5% v of carbon dioxide CO2, remainder being mainly nitrogen N2.

It is preferentially injected at a temperature comprised between 850 and 1200° C.

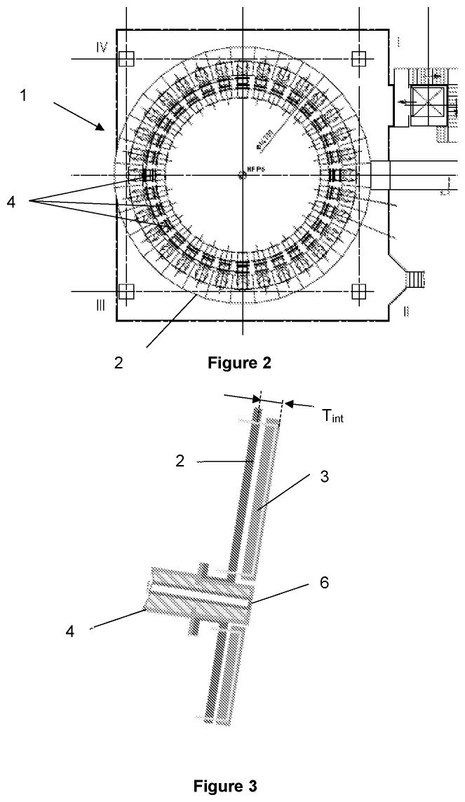

The injection is performed through several injection devices 4, provided with injection outlets 6, around the circumference of the furnace, as illustrated in FIG. 2, which is a top view of the blast furnace 1 at the level of injection of the reducing gas. In a preferred embodiment there are as many injection devices 4 as staves forming the internal wall 5. Between 200 and 700 Nm³ of reducing gas are injected per tons of hot metal in the blast furnace.

FIG. 3 illustrates a side view of a blast furnace 1 according to an embodiment of the invention in an injection area. The injection device 4 is inserting into the blast furnace 1 by going through the shell 2 and the staves 3 forming the internal wall 5. The staves above and below the injection device have a thickness Tᵢₙₜ which is substantially constant and the injection outlet 6 is aligned with the internal wall 5. As staves are subjected to abrasion by the matters falling into the blast furnace their thickness can't be precisely known and controlled, by substantially constant it is thus meant that the variation of the thickness is inferior or equal to 2%. In a preferred embodiment the thickness Tᵢₙₜ of the internal wall is substantially constant over a height of at least 400 mm above and at least 400 mm below the injection outlet. Moreover, according to the invention, the injection device 4 is designed so that the injection outlet 6 is aligned with the internal wall 5 and the reducing gas is injected at a speed inferior to 120 m/s, and preferably below 100 m/s. By doing so the reducing gas injection will not push over the matter falling into the blast furnace and thus not create any cavity which would impair the good distribution of the burden due to the formation of mixed layers of coke and iron-bearing materials and thus the productivity of the ironmaking process.

What is claimed is:

1-6. (canceled)

7: A blast furnace for ironmaking production, iron ore being at least partly reduced by a reducing gas injected in a stack of the blast furnace, the blast furnace comprising:
an external wall;
an internal wall in contact with matters charged into the blast furnace, the internal wall having a thickness Tᵢₙₜ; and
an injector for injecting the reducing gas through an injection outlet in an injection area,
the thickness Tᵢₙₜ of the internal wall being constant above and below the injection area;
the injection outlet being is aligned with the internal wall; and
the injector capable of injecting the reducing gas at a speed inferior to 120 m/s.

8: The blast furnace as recited in claim 7 wherein the thickness Tᵢₙₜ of the internal wall is constant over a height of at least 400 mm above and at least 400 mm below the injection area.

9: The blast furnace as recited in claim 7 wherein the blast furnace has a working height and the reducing gas injection of the injector is performed at a height w between 20% and 70% of the working height H, starting from a tuyere level.

10: An ironmaking method performed in the blast furnace as recited in claim 7 wherein the reducing gas contains part of top gas exhausted from the blast furnace during the ironmaking process.

11: The method as recited in claim 10 wherein the reducing gas is injected at a temperature between 850° C. and 1200° C.

12: The method as recited in claim 10 wherein the reducing gas has the following composition by volume:
65%≤CO≤75%
8%≤H₂≤15%
1%≤CO₂≤5%
a remainder being N2.
